(19) United States
(12) Patent Application Publication
(10) Pub. No.: US 2026/0082447 A1
(43) Pub. Date: Mar. 19, 2026

(54) GLOBAL NAVIGATION SATELLITE SYSTEM MEASUREMENT IN NON-TERRESTRIAL NETWORKS

(71) Applicant: Samsung Electronics Co., Ltd., Suwon-si, Gyeonggi-do (KR)

(72) Inventors: Jonas SEDIN, Staines (GB); Chadi KHIRALLAH, Staines (GB)

(21) Appl. No.: 19/107,316

(22) PCT Filed: Sep. 19, 2023
(86) PCT No.: PCT/KR2023/014147

§ 371 Date: Feb. 27, 2025

(30) Foreign Application Priority Data
Sep. 30, 2022 (GB) 2214419.0
Sep. 11, 2023 (GB) 2313814.2

(51) Int. Cl. H04W 76/27; H04B 7/185

(52) U.S. Cl. CPC H04W 76/27; H04B 7/18513

(57) ABSTRACT

The disclosure relates to a 5G or 6G communication system for supporting a higher data transmission rate. There is disclosed a method of a terminal in a wireless communication network, the method comprising: receiving, from a base station, an indication to leave Radio Resource Control (RRC) Connected mode to perform global navigation satellite system (GNSS) measurement; and in response to receiving the indication, leaving RRC Connected mode and performing GNSS measurement.

### TECHNICAL FIELD

Certain examples of the present disclosure provide various techniques relating to global navigation satellite system (GNSS) measurement, in particular in non-terrestrial networks (NTN).

### BACKGROUND ART

5G mobile communication technologies define broad frequency bands such that high transmission rates and new services are possible, and can be implemented not only in “Sub 6 GHz” bands such as 3.5GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present invention has been made to address at least the above problems and/or disadvantages and to provide at least the advantages described below. Accordingly, for more enhanced communication system, there is a need for method and apparatus for global navigation satellite system measurement in non-terrestrial networks.

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims.

Embodiments or examples disclosed in the description and/or figures falling outside the scope of the claims are to be understood as examples useful for understanding the present invention.

Other aspects, advantages, and salient features of the invention will become apparent to those skilled in the art from the following detailed description taken in conjunction with the accompanying drawings.

### Advantageous Effects of Invention

Advantages, and salient features of the invention will become apparent to those skilled in the art from the following detailed description, which, taken in conjunction with the annexed drawings, discloses exemplary embodiments of the invention. Accordingly present invention, global navigation satellite system measurement in non-terrestrial networks can be performed efficiently.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1a illustrates known examples of IoT NTN GNSS validity operation;

FIG. 1b illustrates known examples of IoT NTN GNSS validity operation;

FIG. 2 illustrates an example of GNSS measurement being performed;

FIG. 3 is a flow chart illustrating certain examples of the present disclosure;

FIG. 4 illustrates an example of NG-RAN including a new cause value in the UE Context Release Request procedure;

FIG. 5 illustrates a structure of the UE to which embodiments of the disclosure can be applied;

FIG. 6 illustrates a structure of the base station to which embodiments of the disclosure can be applied.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

In the present disclosure, the following abbreviations and definitions may be used.
3GPP 3rd Generation Partnership Project
5G 5th Generation
5GC 5G Core
A-GNSS Assistance GNSS
AI Artificial intelligence
AMF Access and Mobility Management Function
AS Access stratum
CFRA Contention-free random access
gNB 5G base station
GNSS Global navigation satellite system
IoT Internet of things
MME Mobile management entity
NG Interface between 5G RAN and Core
NR New Radio
NTN Non-terrestrial network
RAN Radio access network
Rel Release
RLF Radio link failure
RRC Radio Resource Control
S1 Interface between Long Term Evolution RAN and evolved packet core
SIB System information black
TS Technical Specification
UE User Equipment
X2 Interface between 2 base stations
Xn Interface between nodes

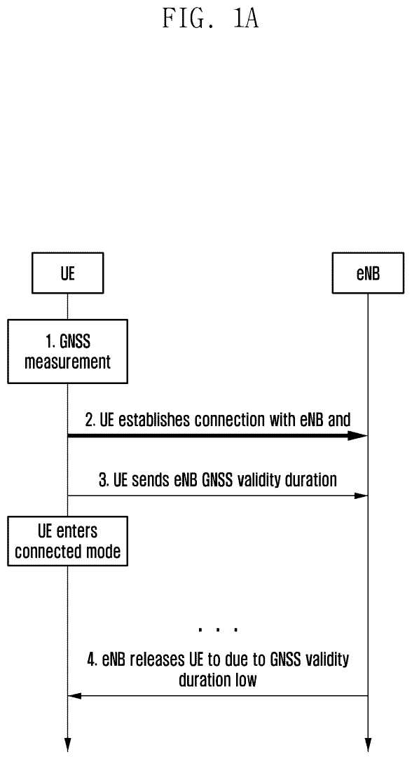

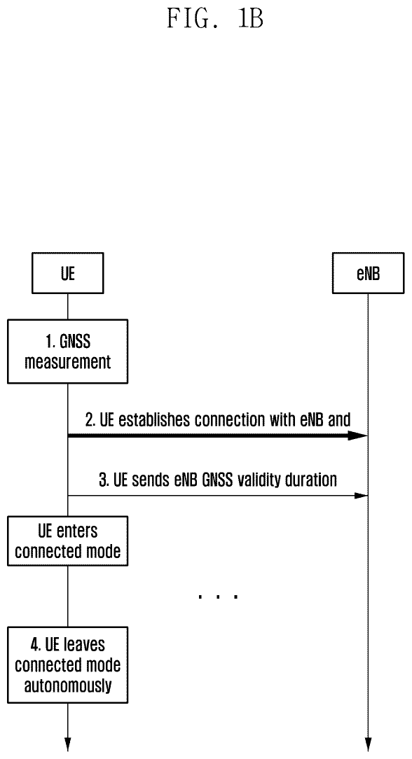

Both Internet of Things (IOT) NTN and 5G New Radio (NR) NTN are heavily reliant on GNSS in order to synchronize in frequency and in time as well as to determine correct configuration and whether a user equipment (UE) is allowed to operate in a cell or not. However, due to the nature of how GNSS usually is in a separate part of the device and that how GNSS operates is not standardized, it is not specified when a UE shall perform GNSS measurement in current specifications. It is rather specified as a requirement that the UE shall have a recent and precise enough GNSS position. For instance the UE is required to have determined its own position to be used for time and frequency-synchronization and in IoT NTN the UE is required to report its GNSS validity duration in certain radio resource control (RRC) messages. Furthermore, if the GNSS is deemed to be invalid and the UE is in RRC Connected mode, the UE shall move to RRC Idle mode. This operation can be seen in FIG. 1, which shows IoT NTN GNSS validity operation. In (a) is the expected network-controlled operation where the network releases the UE to ensure that eNB knows the state of the UE, and in (b) the UE releases itself autonomously according to the specification.

3GPP TS 36.331 v17.1.0 recites:
5.3.3.21 UE actions upon indication of out-of-date GNSS position

Upon indication that the GNSS position has become out-of-date while in RRC_CONNECTED, the UE shall:
1> perform the actions upon leaving RRC_CONNECTED as specified in 5.3.12, with release cause ‘other’.

In Release 18 IOT NTN WI (RP-220979) the following is stated:
Study and specify, if needed, improved GNSS operations for a new position fix for UE pre-compensation during long connection times and for reduced power consumption. Simultaneous GNSS and NTN NB-IOT/eMTC operation is not assumed.

### [RAN1]

And in RAN1 #109 Chair notes the following agreements was taken:

### Conclusion

IoT NTN UE may need to re-acquire a valid GNSS position fix in long connection time.
FFS: Whether and how to update or reduce the need to update GNSS position fix in long connection time

### Agreement

Closed loop time and frequency correction, with potential enhancements, for IoT-NTN is considered to reduce the need for UE to update GNSS position fix in long connection time

### Agreement

At least the following options can be considered on GNSS measurement in connected for potential enhancements for improved GNSS operations:
Option 1: UE re-acquires GNSS position fix during RLF procedure
Option 2: UE re-acquires GNSS position fix with a new gap

Note: this does not imply that a Rel-18 IoT NTN UE is mandated to support one or both of the options.

R1-2205553Feature lead summary #2 of AI 9.12.3 on improved GNSS operations Moderator (MediaTek)

### Agreement

UE reports additional GNSS assistance information and further study the detailed GNSS assistance information, including e.g. GNSS position fix measurement time
Note: Since RAN1 agreed that GNSS validity duration is reported by UE in Rel-17, it is already included in GNSS assistance information.

### Agreement

Further study on whether there is a need for potential enhancements on the following for long connection time
UE triggered GNSS measurement.
Network triggered GNSS measurement.

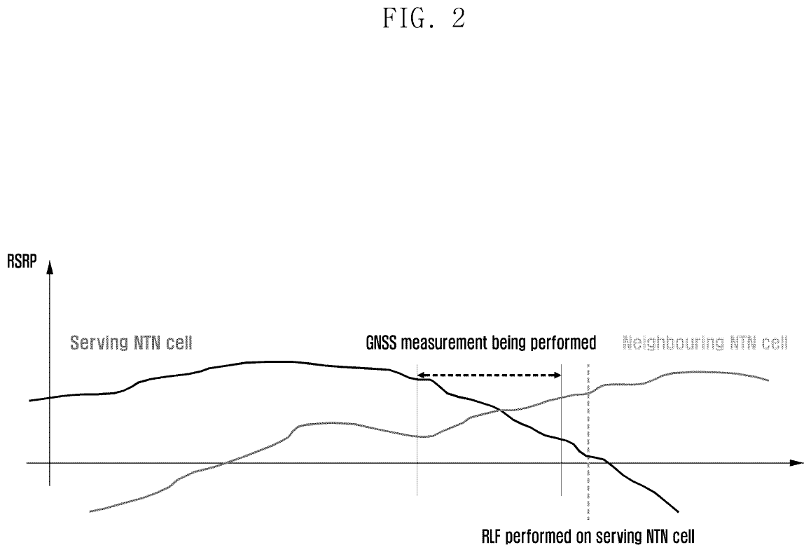

However, the above agreements may overlook a significant issue of the unpredictable time needed to perform a GNSS measurement. As an example, due to the movement of the satellite there is the possibility that when the UE stays in connected mode and performing GNSS measurement, when the UE finishes its GNSS measurement a new cell might be more suitable than the serving cell that might have its signal strength reduced significantly. This can be seen in FIG. 2. FIG. 2 illustrates an example of GNSS measurement being performed and when GNSS measurement has finished, due to the movement of the satellites and the time that it takes to perform GNSS measurement, a neighbouring cell is now stronger.

In order to have GNSS operation that is more suitable for IoT NTN operation, some new methods are needed.

The above information is presented as background information only to assist with an understanding of the present disclosure. No determination has been made, and no assertion is made, as to whether any of the above might be applicable as prior art with regard to the present invention.

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but, are merely used to enable a clear and consistent understanding of the examples disclosed herein.

Throughout the description and claims, the words “comprise”, “contain” and “include”, and variations thereof, for example “comprising”, “containing” and “including”, means “including but not limited to”, and is not intended to (and does not) exclude other features, elements, components, integers, steps, processes, functions, characteristics, and the like.

Throughout the description and claims, the singular form, for example “a”, “an” and “the”, encompasses the plural unless the context otherwise requires. For example, reference to “an object”includes reference to one or more of such objects.

Throughout the description and claims, language in the general form of “X for Y” (where Y is some action, process, function, activity or step and X is some means for carrying out that action, process, function, activity or step) encompasses means X adapted, configured or arranged specifically, but not necessarily exclusively, to do Y.

Features, elements, components, integers, steps, processes, functions, characteristics, and the like, described in conjunction with a particular aspect, embodiment, example or claim are to be understood to be applicable to any other aspect, embodiment, example or claim disclosed herein unless incompatible therewith.

The following examples are applicable to, and may use terminology associated with, IoT NTN and 3GPP 5G-NR NTN. However, the skilled person will appreciate that the techniques disclosed herein are not limited to these examples, and may be applied in any suitable system or standard, for example one or more existing and/or future generation wireless communication systems or standards. The skilled person will appreciate that the techniques disclosed herein may be applied in any existing or future releases or any other relevant standard.

For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network.

The skilled person will appreciate that the present invention is not limited to the specific examples disclosed herein. For example:
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.
Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g. a network) comprising one or more such apparatuses/devices/network entities, and/or a method therefor. For example, in the following examples, a network may include one or more IAB nodes.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, claim, example and/or embodiment disclosed herein. Certain embodiments of the present disclosure provide a machine-readable storage storing such a program.

The terms ‘terminal’ and ‘user equipment’ (‘UE’) are used interchangeably throughout the present disclosure.

All proposals, embodiments, and examples in this invention may apply to the IoT NTN case but may also apply for the gNB, NG-RAN case and all related RRC signaling and/or messages, and X2, Xn, S1, NG signaling and messages, and /r related network entities (e.g. MME, AMF, other). All proposals, embodiments, and examples in this invention may also apply for 5G-NR NTN.

Certain examples of the present disclosure involve the network explicitly ordering the UE to go to RRC Idle or RRC Inactive mode in order to perform GNSS measurement or to suspend the RRC connection in order to perform GNSS measurement, using RRC signalling (e.g. RRC Connection Release/Reject message/RRC Connection Release with suspend indication). A benefit of this is that instead of having the UE staying in RRC connected mode, the network can release the related resources and that the eNB implementation becomes more simple since the state of the UE is not unknown.

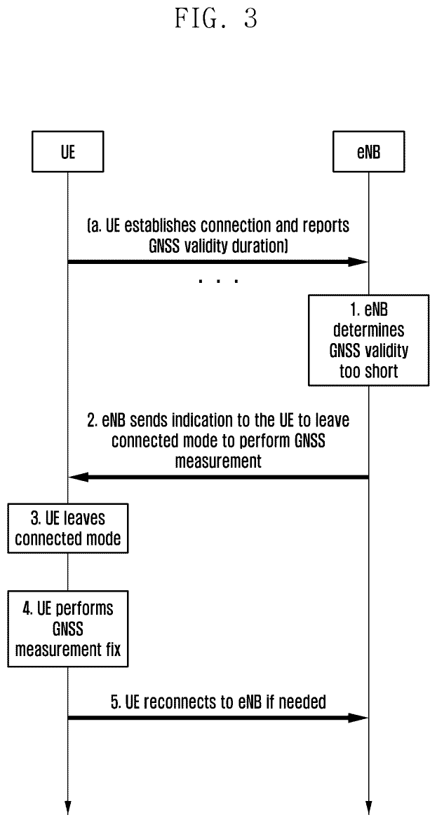

FIG. 3 is a flow chart illustrating certain examples of the present disclosure.

In step a. the UE establishes connection with a base station. For example, the UE may establish connection with the base station through RRC Connection Establishment. The UE may provide the base station with a GNSS validity duration. For example, a message indicating GNSS validity duration may be transmitted during the RRC Connection establishment.

In step 1, the base station may identify an issue related to GNSS measurement. For example, the base station may determine that the GNSS validity duration is too short. However, the issue related to GNSS measurement is not limited to the GNSS validity duration being too short, as explained in more detail below.

In step 2 the base station may send an indication configuring the UE to leave RRC Connected mode to perform GNSS measurement. For example, the base station may transmit to the UE, an indication to leave RRC Connected mode to perform GNSS measurement.

In step 3, the UE may leave RRC Connected mode. For example, in response to receiving the indication to leave RRC Connected mode to perform GNSS measurement, the UE may leave RRC Connected mode. In certain examples, leaving RRC Connected mode may comprise entering RRC Idle mode, entering RRC Inactive mode, or suspending RRC connection.

In step 4, the UE may perform a GNSS measurement fix while in RRC Idle or RRC Inactive mode, or with the RRC connection suspended. For example, in response to receiving the indication to leave RRC Connected mode to perform GNSS measurement, and after leaving RRC Connected mode, the UE may perform GNSS measurement.

In step 5, the UE reconnects to the base station (or a different base station) if needed. For example, after performing GNSS measurement, the UE may re-enter RRC Connected mode. In certain examples, re-entering RRC Connected mode may comprise connecting to another base station in the case that the UE detects that a cell belonging to the other base station is more suitable than a cell of the original base station.

As described above, in certain examples the base station may receive a GNSS validity duration indication from the UE, may determine that the GNSS validity duration is too short based on the GNSS validity duration indication, and, if it is determined that the GNSS validity duration is too short, may transmit, to the UE, an indication to leave RRC Connected mode to perform GNSS measurement.

In certain examples, the GNSS validity duration is received from the UE during RRC Connection establishment. In certain examples the GNSS validity duration is received in an RRC Setup Complete message (Msg5).

In certain examples, determining that the GNSS validity duration is too short may comprise comparing the GNSS validity duration to a predefined range or threshold value. For example, determining that the GNSS validity duration is too short may comprise determining that the GNSS validity duration is too short when it is determined that the GNSS validity duration is less than a predetermined threshold value.

In certain examples, identifying an issue related to GNSS measurement (e.g. determining that the GNSS validity duration is too short) takes place while the UE is in RRC Connected mode.

In certain examples, the base station is not limited to indicating the UE to leave RRC Connected mode to perform GNSS measurement when it is determined that the GNSS validity duration is too short, and the base station may additionally or alternatively indicate the UE to leave RRC Connected mode to perform GNSS measurement based on other GNSS related factors. That is, the base station may identify an issue related to GNSS measurement of a UE, and in response to identifying the issue related to GNSS measurement of the UE, may transmit, to the UE, an indication to leave RRC Connected mode to perform GNSS measurement. As described above, the base station may receive, from the UE, a message indicating a GNSS validity duration, and may identify an issue related to GNSS measurement of a UE when it is determined that the GNSS validity duration received from the UE is too short. In another example, the base station may identify issues with a specific UE being out-of-synch, which can be learned through detecting that the UE is un-synchronized in frequency and/or timing. That is, the base station may identify an issue related to GNSS measurement when it is determined that the UE is un-synchronized in frequency and/or timing. In another example, the base station may identify a need to communicate during a longer period of time, such as during a software update or other need for communication to last for a longer time. This may involve the base station identifying an issue related to GNSS measurement when it is determined that a particular current or future communication will exceed a predetermined time threshold. In another example, the base station may predict whether a UE is likely to not be synchronized anymore. This may involve identifying an issue related to GNSS measurement when it is determined that a UE is likely to lose synchronization. The determination may be based on, for example, a threshold probability of synchronization loss, a probability of synchronization loss within a threshold time, and/or an AI-based algorithm.

As described above, in certain examples, the base station transmits, to the UE, an indication to leave RRC Connected mode to perform GNSS measurement

In certain examples, the base station sends the indication to leave RRC Connected mode to perform GNSS measurement in an RRC release message, which may include a release cause. This can for instance be a release cause named ‘GNSS validity duration too short’, ‘GNSS out-of-synch’ or ‘GNSS measurement to be performed’ or any other suitable cause.

In certain examples, if the release cause value indicates that GNSS measurement is required (e.g. ‘GNSS measurement to be performed’) the UE may ignore or reject the request to leave RRC Connected mode (e.g. the request to move to RRC Idle or RRC Inactive mode, or to suspend the RRC connection) to perform GNSS measurement. The UE may stay in a current state (e.g. RRC Connected mode) to perform the GNSS measurement. For example, the terminal may receive, from a base station, an indication to leave RRC Connected mode to perform GNSS measurement; may determine whether to leave RRC Connected mode to perform GNSS measurement; may leave RRC Connected mode to perform the GNSS measurement if it is determined to leave RRC Connected mode to perform the GNSS measurement; and may remain in RRC Connected mode to perform the GNSS measurement if it is determined not to leave RRC Connected mode to perform the GNSS measurement. In certain examples, the UE may indicate to the base station the reason for rejecting to move to RRC Idle or RRC Inactive or rejecting to suspend the RRC connection, e.g. the UE does not have a coverage of the satellite to achieve a good GNSS measurement, the UE will be losing satellite coverage and will not have enough time to perform the requested measurement, the UE has urgent data to send, or any other suitable reason. Another reason may be that the UE is a more advanced UE that has the ability to perform GNSS measurements in parallel with communicating with the network, as there is currently no way for the network to know that the UE has this capability.

In certain examples, the UE may ignore or reject the network request to perform GNSS measurement, but may still move to RRC Idle or RRC Inactive mode or still suspend the RRC connection. The UE may indicate to the network the reason for not performing requested GNSS measurement, e.g. the UE does not have a coverage of the satellite to achieve a good GNSS measurement, the UE will be losing satellite coverage and will not have enough time to perform the requested measurement, the UE has urgent data to send, or any other suitable reason.

In certain examples, the reject reason may be carried over an RRC message and the reasons for a UE to reject a message to perform GNSS measurement or to move RRC Idle or RRC Inactive mode (or to suspend the RRC connection) can either be configured by the network through broadcast or may be indicated in the RRC Release/Reject message.

In certain examples, the base station sends the indication to leave RRC Connected mode to perform GNSS measurement in an RRC Connection reject message.

In certain examples, the UE is configured to go to RRC Inactive mode to perform GNSS measurement or to suspend the RRC connection to perform GNSS measurement. For example, the UE may go to RRC Inactive mode by sending the RRC Connection Release with RRC suspend indication. In RRC Inactive mode, or when the RRC connection is suspended, the UE may retain Access Stratum (AS) configurations while performing GNSS measurement. This allows for faster resumption of data transmissions and also allows for faster resumption if the UE detects a stronger cell after having performed the GNSS measurement.

In certain examples, the UE is configured to go to RRC Idle mode when performing GNSS measurement.

In certain examples, the base station or network indicates the minimum needed GNSS validity duration value in the requested GNSS measurement.

In certain examples, the base station or network indicates the needed precision to be achieved during the GNSS measurements. This can be for instance be in the form of a binary (precise/imprecise) request or a request with a specific minimum precision or precision range in mind. In addition to the requested precision the base station or network may also indicate a minimum desired or needed GNSS validity duration. For example, the indication to leave RRC Connected mode to perform GNSS measurement may include one or more of a minimum required GNSS validity duration value, and a minimum required GNSS measurement precision.

In certain examples, the base station or network includes assistance GNSS (A-GNSS) with the request to leave RRC Connected mode and perform GNSS measurement. This is then used by the UE to shorten the time to perform a GNSS measurement.

In certain examples, the UE is given a contention-free random access (CFRA) preamble in the request to leave RRC Connected mode to perform GNSS measurement. This CFRA can either be used only for the serving cell or also be used for other cells (e.g. neighbouring cells).

After having performed the GNSS measurement in RRC Idle or RRC Inactive mode, or with RRC connection suspended, the UE may need to reconnect to enter RRC connected mode to either send UL data or receive DL data.

In certain examples, the UE is not required to read the SIB31 to acquire the ephemeris information once the GNSS measurement has finished, either in RRC Idle or RRC Inactive mode, or with RRC connection suspended. That is, the UE may be configured without the requirement to read the SIB31 to acquire the ephemeris information when connecting to a NTN, or the UE may be configured to ignore the requirement to read the SIB31 to acquire the ephemeris information when connecting to a NTN if it has recently performed GNSS measurement in RRC Idle or RRC Inactive mode or with RRC connection suspended.

In certain examples, the UE reconnects to another base station if it detects that a cell belonging to the other base station is more suitable than a cell of the original base station. For example, the UE may detect that a signal strength of another cell is now stronger than a signal strength of the original cell, and may reconnect to the corresponding base station. However, the disclosure is not limited thereto, and any measure of suitability may be used to determine the most suitable cell for re-entering RRC Connected mode.

In certain examples, the base station includes an indication that the UE shall reconnect once it has finished performing the GNSS measurement. This indication may be implied by the network in the release or reject message, or it might be a separate flag that indicates whether the UE shall reconnect or not. That is, the UE may receive, from the base station, a configuration for configuring the terminal to re-enter RRC Connected mode after performing GNSS measurement.

In certain examples, when reconnecting, the UE performs CFRA to either the serving cell or another cell, if it has been configured with a CFRA preamble.

In certain examples, if configured by the network, the UE may decide to release itself due to GNSS related issues (e.g. GNSS validity duration, other), and optionally, may indicate to the network (base station) the release, which may include the reason for the release. That is, the network (base station) may transmit, to the UE a configuration for configuring the UE to determine itself to leave RRC Connected mode to perform GNSS measurement, and when the UE determines to leave RRC connected mode, the UE may (optionally) indicate to the network (base station) that the UE will leave RRC Connected mode. The indication may include a release cause. The release cause can for instance be a release cause named ‘GNSS validity duration too short’, ‘GNSS out-of-synch’ or ‘GNSS measurement to be performed’or similar.

For example, the terminal may determine to leave RRC Connected mode to perform GNSS measurement, and, in response to determining to leave RRC Connected mode to perform GNSS measurement, may leave RRC Connected mode and perform GNSS measurement. Determining to leave RRC Connected mode to perform GNSS measurement may comprise identifying an issue related to GNSS measurement. The determination to leave RRC Connected mode to perform GNSS measurement may be based on identifying an issue related to GNSS measurement.

In an alternative, if configured by the network, the UE may decide to request its release, e.g. to RRC Idle mode or RRC Inactive mode (with suspend indication) or to suspend RRC connection, from the network due to GNSS related issues (e.g. GNSS validity duration, other), and optionally, may indicate to the network (base station) the reason for the release. This can for instance be a release cause named ‘GNSS validity duration too short’, ‘GNSS out-of-synch’ or ‘GNSS measurement to be performed’ or similar. The GNSS validity duration may be included in the request. The base station may receive the request, may determine whether to grant the request, and may transmitting, to the UE, an indication to leave RRC Connected mode to perform GNSS measurement if it is determined to grant the request. The base station may determine not to grant the request if, for example, it is determined that the GNSS validity duration is still long enough in order for the traffic to be delivered in time, or if it is determined that a particular or important message or configuration is to be delivered.

For example, the terminal may identify an issue related to GNSS measurement, and, in response to identifying the issue related to GNSS measurement, may transmit, to a base station, a request to leave RRC connected mode to perform GNSS measurement.

In certain examples, the base station (eNB or gNB) sends an indication to the AMF or MME about releasing the UE context. As an example specific to 5GC, the NG-RAN may trigger the UE Context Release Request procedure to request the AMF to release UE context and indicate the appropriate cause value for the release, e.g. ‘GNSS validity duration too short’, ‘GNSS out-of-synch’ or ‘GNSS measurement to be performed’ or similar.

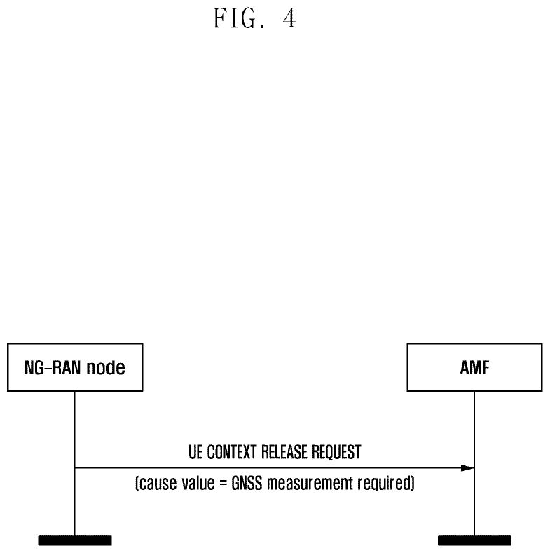

FIG. 4 shows an example of NG-RAN including a new cause value=“GNSS measurement required” in the UE Context Release Request procedure (i.e. moving UE out of RRC_CONNECTED state) to request the AMF to release UE context.

According to a first example, a method of a terminal in a wireless communication network is provided, the method comprising: receiving, from a base station, an indication to leave RRC Connected mode to perform GNSS measurement; and in response to receiving the indication, leaving RRC Connected mode and performing GNSS measurement.

According to a second example, a method of a terminal in a wireless communication system is provided, the method comprising: receiving, from a base station, an indication to leave RRC Connected mode to perform GNSS measurement; determining whether to leave RRC Connected mode to perform GNSS measurement; leaving RRC Connected mode to perform the GNSS measurement in the case that it is determined to leave RRC Connected mode to perform the GNSS measurement; and remaining in RRC Connected mode to perform the GNSS measurement in the case that it is determined not to leave RRC Connected mode to perform the GNSS measurement.

According to a third example, the method of the first or second example is provided, further comprising: re-entering RRC Connected mode after performing GNSS measurement.

According to a fourth example, the method of the third example is provided, wherein re-entering RRC Connected mode comprises connecting to another base station in the case that the UE detects that a cell belonging to the another base station is more suitable than a cell of the original base station.

According to a fifth example, the method of the third or fourth example is provided, wherein the indication to leave RRC Connected mode to perform GNSS measurement includes a contention-free random access (CFRA) preamble; and wherein re-entering RRC Connected mode comprises performing CFRA to a cell based on the CFRA preamble.

According to a sixth example, the method of any preceding example is provided, wherein the indication to leave RRC Connected mode to perform GNSS measurement includes assistance GNSS (A-GNSS) information; and wherein performing GNSS measurement comprises performing GNSS measurement using the A-GNSS information.

According to a seventh example, the method of any preceding example is provided, wherein the indication to leave RRC Connected mode to perform GNSS measurement includes one or more of: a minimum required GNSS validity duration value, and a minimum required GNSS measurement precision.

According to an eighth example, the method of any preceding example is provided, wherein the indication to leave RRC Connected mode to perform GNSS measurement is included in an RRC release message or an RRC connection reject message, and wherein the RRC release message or RRC connection reject message includes a release cause.

According to a ninth example, a method of a terminal in a wireless communication network is provided, the method comprising: identifying an issue related to GNSS measurement; and in response to identifying the issue related to GNSS measurement, transmitting, to a base station, a request to leave RRC connected mode to perform GNSS measurement.

According to a tenth example, a method of a terminal in a wireless communication network is provided, the method comprising: determining to leave RRC Connected mode to perform GNSS measurement; and in response to determining to leave RRC Connected mode to perform GNSS measurement, leaving RRC Connected mode and performing GNSS measurement.

According to an eleventh example, the method of the ninth or tenth example is provided, further comprising: re-entering RRC Connected mode after performing GNSS measurement.

According to a twelfth example, the method of the eleventh example is provided, wherein re-entering RRC Connected mode comprises connecting to another base station in the case that the UE detects that a cell belonging to the another base station is more suitable than a cell of the base station to which the UE was connected before leaving the RRC connected mode.

According to a thirteenth example, the method of any preceding example is provided, wherein leaving the RRC Connected mode comprises entering RRC Idle mode, entering RRC Inactive mode, or suspending the RRC connection.

According to a fourteenth example, the method of any preceding example is provided, wherein the method further comprises: transmitting, to the base station, a message indicating a GNSS validity duration.

According to a fifteenth example, the method of the fourteenth example is provided, wherein the method further comprises: establishing an RRC Connection with the base station; wherein the message indicating the GNSS validity duration is transmitted during the RRC Connection establishment.

According to a sixteenth example, a method of a base station in a wireless communication network is provided, the method comprising: identifying an issue related to GNSS measurement of a UE; and in response to identifying the issue related to GNSS measurement of the UE, transmitting, to the UE, an indication to leave RRC Connected mode to perform GNSS measurement.

According to a seventeenth example, the method of the sixteenth example is provided, further comprising receiving, from the UE, a message indicating a GNSS validity duration; wherein identifying an issue related to GNSS measurement of a UE comprises determining that the GNSS validity duration received from the UE is too short.

According to an eighteenth example, the method of the sixteenth or seventeenth example is provided, wherein the indication to leave RRC Connected mode to perform GNSS measurement includes one or more of: a contention-free random access (CFRA) preamble, assistance GNSS (A-GNSS) information, a minimum required GNSS validity duration value, and a minimum required GNSS measurement precision.

According to a nineteenth example, the method of any of the sixteenth to eighteenth examples is provided, wherein the indication to leave RRC Connected mode to perform GNSS measurement is included in an RRC release message or an RRC connection reject message, and wherein the RRC release message or RRC connection reject message includes a release cause.

According to a twentieth example, the method of any of the sixteenth to nineteenth examples is provided, the method further comprising transmitting to an Access and Mobility Management Function (AMF) or Mobile Management Entity (MME) an indication to release the UE context.

According to a twenty-first example, a terminal configured to operate according to a method of any of the first to fifteenth examples is provided.

According to a twenty-second example, a base station configured to operate according to a method of any of the sixteenth to twentieth examples is provided.

According to a twenty-third example, a network or wireless communication system comprising a terminal according to the twenty-first example and a base station according to the twenty-second example are provided.

According to a twenty-fourth example, a computer program comprising instructions which, when the program is executed by a computer or processor, cause the computer or processor to carry out a method according to any of the first to twentieth examples is provided.

According to a twenty-fifth example, a computer or processor-readable data carrier having stored thereon a computer program according to the twenty-fourth example is provided.

According to a twenty-sixth example, there is provided a method of a terminal in a wireless communication network, the method comprising: receiving, from a base station, an indication to leave Radio Resource Control (RRC) Connected mode to perform global navigation satellite system (GNSS) measurement; and in response to receiving the indication, leaving RRC Connected mode and performing GNSS measurement.

According to a twenty-seventh example, there is provided the method of the twenty-sixth example, wherein leaving the RRC Connected mode comprises entering RRC Idle mode, entering RRC Inactive mode, or suspending the RRC connection.

According to a twenty-eighth example, there is provided the method of the twenty-sixth or twenty-seventh example, further comprising: re-entering RRC Connected mode after performing GNSS measurement.

According to a twenty-ninth example, there is provided the method of the twenty-eighth example, wherein re-entering RRC Connected mode comprises connecting to another base station in the case that the UE detects that a cell belonging to the another base station is more suitable than a cell of the original base station.

According to a thirtieth example, there is provided the method of the twenty-eight or twenty-ninth example, wherein the indication to leave RRC Connected mode to perform GNSS measurement includes a contention-free random access (CFRA) preamble; and wherein re-entering RRC Connected mode comprises performing CFRA to a cell based on the CFRA preamble.

According to a thirty-first example, there is provided the method of any of the twenty-sixth to thirtieth examples, further comprising: transmitting, to the base station, a message indicating a GNSS validity duration.

According to a thirty-second example, there is provided the method of the thirty-first example, further comprising: establishing an RRC Connection with the base station; wherein the message indicating the GNSS validity duration is transmitted during the RRC Connection establishment.

According to a thirty-third example, there is provided the method of any of the twenty-sixth to thirty-second examples, wherein the indication to leave RRC Connected mode to perform GNSS measurement includes assistance GNSS (A-GNSS) information; and wherein performing GNSS measurement comprises performing GNSS measurement using the A-GNSS information.

According to a thirty-fourth example, there is provided the method of any of the twenty-sixth to thirty-third examples, wherein the indication to leave RRC Connected mode to perform GNSS measurement includes one or more of: a minimum required GNSS validity duration value, and a minimum required GNSS measurement precision.

According to a thirty-fifth example, there is provided the method of any of the twenty-sixth to thirty-fourth examples, wherein the indication to leave RRC Connected mode to perform GNSS measurement is included in an RRC release message or an RRC connection reject message, and wherein the RRC release message or RRC connection reject message includes a release cause.

According to a thirty-sixth example, there is provided a method of a terminal in a wireless communication network, the method comprising: identifying an issue related to global navigation satellite system (GNSS) measurement; and in response to identifying the issue related to GNSS measurement, transmitting, to a base station, a request to leave Radio Resource Control (RRC) connected mode to perform GNSS measurement.

According to a thirty-seventh example, there is provided a method of a terminal in a wireless communication system, the method comprising: receiving, from a base station, an indication to leave Radio Resource Control (RRC) Connected mode to perform global navigation satellite system (GNSS) measurement; determining whether to leave RRC Connected mode to perform GNSS measurement; leaving RRC Connected mode to perform the GNSS measurement in the case that it is determined to leave RRC Connected mode to perform the GNSS measurement; and remaining in RRC Connected mode to perform the GNSS measurement in the case that it is determined not to leave RRC Connected mode to perform the GNSS measurement

According to a thirty-eighth example, there is provided a method of a terminal in a wireless communication network, the method comprising: determining to leave Radio Resource Control (RRC) Connected mode to perform global navigation satellite system (GNSS) measurement; and in response to determining to leave RRC Connected mode to perform GNSS measurement, leaving RRC Connected mode and performing GNSS measurement.

According to a thirty-ninth example, there is provided a method of a base station in a wireless communication network, the method comprising: identifying an issue related to global navigation satellite system (GNSS) measurement of a UE; and in response to identifying the issue related to GNSS measurement of the UE, transmitting, to the UE, an indication to leave Radio Resource Control (RRC) Connected mode to perform GNSS measurement.

According to a fortieth example, there is provided the method of the thirty-ninth example, further comprising receiving, from the UE, a message indicating a GNSS validity duration; wherein identifying an issue related to GNSS measurement of a UE comprises determining that the GNSS validity duration received from the UE is too short.

According to a forty-first example, there is provided the method of the thirty-ninth or fortieth example, wherein the indication to leave RRC Connected mode to perform GNSS measurement includes one or more of: a contention-free random access (CFRA) preamble, assistance GNSS (A-GNSS) information, a minimum required GNSS validity duration value, and a minimum required GNSS measurement precision.

According to a forty-second example, there is provided the method of any of the thirty-ninth to forty-first examples, wherein the indication to leave RRC Connected mode to perform GNSS measurement is included in an RRC release message or an RRC connection reject message, and wherein the RRC release message or RRC connection reject message includes a release cause.

According to a forty-third example, there is provided the method of any of the thirty-ninth to forty-second examples, further comprising transmitting to an Access and Mobility Management Function (AMF) or Mobile Management Entity (MME) an indication to release the UE context.

According to a forty-fourth example, there is provided a terminal configured to operate according to a method of any of the twenty-sixth to thirty-eighth examples.

According to a forty-fifth example, there is provided a base station configured to operate according to a method of any of the thirty-ninth to forty-third examples.

According to a forty-sixth example, there is provided a network or wireless communication system comprising a terminal according to the forty-fourth example and a base station according to the forty-fifth example.

According to a forty-seventh example, there is provided a computer program comprising instructions which, when the program is executed by a computer or processor, cause the computer or processor to carry out a method according to any of the twenty-sixth to forty-third examples.

According to a forty-eighth example, there is provided a computer or processor-readable data carrier having stored thereon a computer program according to the forty-seventh example.

While the invention has been shown and described with reference to certain examples, it will be understood by those skilled in the art that various changes in form and detail may be made therein without departing from the scope of the invention, as defined by the appended claims.

Certain examples of the present disclosure provide one or more techniques as disclosed in the appended annex to the description. The skilled person will appreciate that any of these techniques may be applied in combination with any of the techniques described above and illustrated in the Figures.

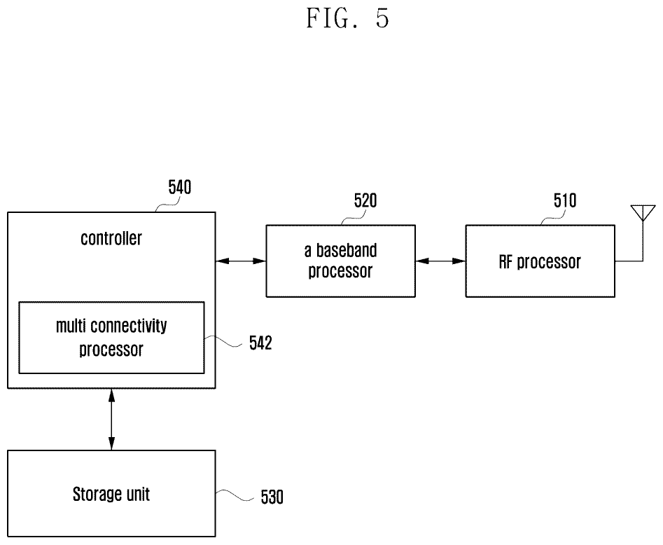

FIG. 5 illustrates a structure of the UE to which embodiments of the disclosure can be applied.

Referring to FIG. 5, the UE includes a radio frequency (RF) processor 510, a baseband processor 520, a storage unit 530, and a controller 540.

The RF processor 510 performs a function for transmitting and receiving a signal through a wireless channel, such as band conversion and amplification of a signal. That is, the RF processor 510 up-converts a baseband signal provided from the baseband processor 520 into an RF band signal, transmits the RF band signal through an antenna, and then down-converts the RF band signal received through the antenna into a baseband signal. For example, the RF processor 510 may include a transmission filter, a reception filter, an amplifier, a mixer, an oscillator, a digital-to-analog converter (DAC), an analog-to-digital converter (ADC), and the like. Although FIG. 5 illustrates only one antenna, the UE may include a plurality of antennas. In addition, the RF processor 510 may include a plurality of RF chains. Moreover, the RF processor 510 may perform beamforming. For the beamforming, the RF processor 510 may control a phase and a size of each signal transmitted/received through a plurality of antennas or antenna elements. The RF processor may perform MIMO and receive a plurality of layers when performing the MIMO operation. The RF processor 510 may appropriately configure a plurality of antennas or antenna elements according to the control of the controller to perform reception beam sweeping or control a direction of a reception beam and a beam width so that the reception beam corresponds to a transmission beam.

The baseband processor 520 performs a function for a conversion between a baseband signal and a bitstream according to a physical layer standard of the system. For example, when data is transmitted, the baseband processor 520 generates complex symbols by encoding and modulating a transmission bitstream. Further, when data is received, the baseband processor 520 reconstructs a reception bitstream by demodulating and decoding a baseband signal provided from the RF processor 510. For example, in an orthogonal frequency division multiplexing (OFDM) scheme, when data is transmitted, the baseband processor 520 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 520 divides the baseband signal provided from the RF processor 510 in the unit of OFDM symbols, reconstructs the signals mapped to the subcarriers through a fast Fourier transform (FFT) operation, and then reconstructs a reception bitstream through demodulation and decoding.

The baseband processor 520 and the RF processor 510 transmit and receive signals as described above. Accordingly, the baseband processor 520 and the RF processor 510 may be referred to as a transmitter, a receiver, a transceiver, or a communication unit. Further, at least one of the baseband processor 520 and the RF processor 510 may include a plurality of communication modules to support a plurality of different radio access technologies. In addition, at least one of the baseband processor 520 and the RF processor 510 may include different communication modules to process signals of different frequency bands. For example, the different radio-access technologies may include an LTE network and an NR network. Further, the different frequency bands may include a super high frequency (SHF) (for example, 2.5 GHz and 5 Ghz) band and a millimeter (mm) wave (for example, 60 GHz) band.

The storage unit 530 stores data such as basic program, an application, and setting information for the operation of the UE. The storage unit 530 provides the stored data according to a request from the controller 540.

The controller 540 controls the overall operation of the UE. For example, the controller 540 transmits/receives a signal through the baseband processor 520 and the RF processor 510. In addition, the controller 540 may record data in the storage unit 530 and read the data. To this end, the controller 540 may include at least one processor. For example, the controller 540 may include a communication processor (CP) that performs a control for communication, and an application processor (AP) that controls a higher layer such as an application program.

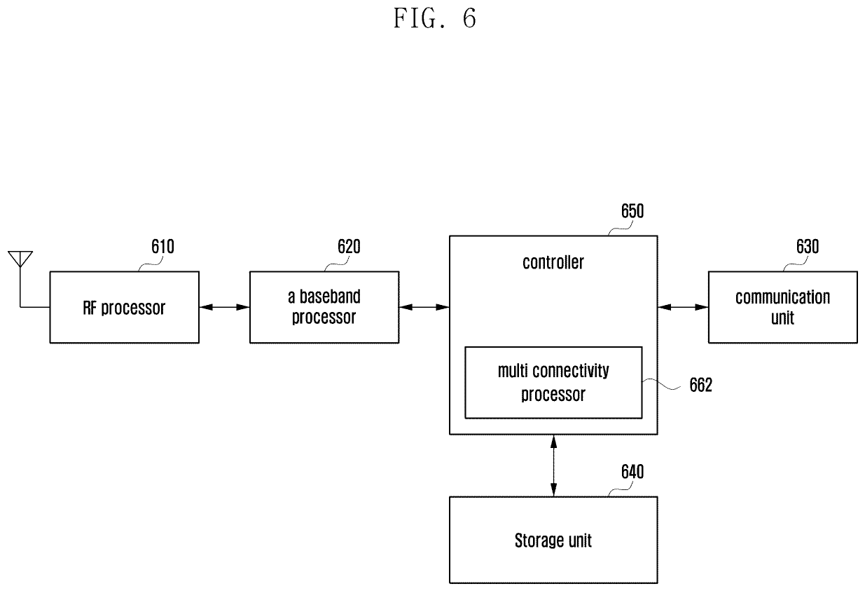

FIG. 6 illustrates a structure of the base station to which embodiments of the disclosure can be applied.

As illustrated in FIG. 6, the base station includes an RF processor 610, a baseband processor 620, a backhaul communication unit 630, a storage unit 640, and a controller 650.

The RF processor 610 performs a function for transmitting and receiving a signal through a wireless channel, such as band conversion and amplification of a signal. That is, the RF processor 610 up-converts a baseband signal provided from the baseband processing unit 620 into an RF band signal and then transmits the converted signal through an antenna, and down-converts an RF band signal received through the antenna into a baseband signal. For example, the RF processor 610 may include a transmission filter, a reception filter, an amplifier, a mixer, an oscillator, a DAC, and an ADC. Although FIG. 6 illustrates only one antenna, the first access node may include a plurality of antennas. In addition, the RF processor 610 may include a plurality of RF chains. Moreover, the RF processor 610 may perform beamforming.

For the beamforming, the RF processor 610 may control a phase and a size of each of the signals transmitted and received through a plurality of antennas or antenna elements. The RF processor may perform a downlink MIMO operation by transmitting one or more layers.

The baseband processor 620 performs a function of performing conversion between a baseband signal and a bitstream according to a physical layer standard of the first radio access technology. For example, when data is transmitted, the baseband processor 620 generates complex symbols by encoding and modulating a transmission bitstream. Further, when data is received, the baseband processor 620 reconstructs a reception bitstream by demodulating and decoding a baseband signal provided from the RF processor 610. For example, in an OFDM scheme, when data is transmitted, the baseband processor 620 may generate complex symbols by encoding and modulating the transmission bitstream, map the complex symbols to subcarriers, and then configure OFDM symbols through an IFFT operation and CP insertion. In addition, when data is received, the baseband processor 620 divides a baseband signal provided from the RF processor 610 in units of OFDM symbols, recovers signals mapped with sub-carriers through an FFT operation, and then recovers a reception bitstream through demodulation and decoding. The baseband processor 620 and the RF processor 610 transmit and receive signals as described above. Accordingly, the baseband processor 620 and the RF processor 610 may be referred to as a transmitter, a receiver, a transceiver, or a communication unit.

The communication unit 630 provides an interface for communicating with other nodes within the network.

The storage unit 640 stores data such as a basic program, an application, and setting information for the operation of the MeNB. Particularly, the storage unit 640 may store information on bearers allocated to the accessed UE and the measurement result reported from the accessed UE. Further, the storage unit 640 may store information on a reference for determining whether to provide multiple connections to the UE or stop the multiple connections. In addition, the storage unit 640 provides data stored therein according to a request from the controller 650.

The controller 650 controls the overall operation of the MeNB. For example, the controller 650 transmits and receives a signal through the baseband processor 620 and the RF processor 610 or through the backhaul communication unit 630. In addition, the controller 650 may record data in the storage unit 640 and read the data. To this end, the controller 650 may include at least one processor.

Although the present disclosure has been described with various embodiments, various changes and modifications may be suggested to one skilled in the art. It is intended that the present disclosure encompass such changes and modifications as fall within the scope of the appended claims.

The various actions, acts, blocks, steps, or the like in the flow charts may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method performed by a terminal in a wireless communication network, the method comprising:
receiving, from a first base station, a first message including first information indicating to perform a global navigation satellite system (GNSS) measurement in a radio resource control (RRC) inactive mode or an RRC idle mode, in an RRC connected mode;
based on the first information, performing the GNSS measurement in the RRC inactive mode or the RRC idle mode; and
re-entering an RRC connected mode with a second base station, wherein a suitable cell belong to the second base station.

2. The method of claim 1, the method further comprising:
in case that the first message further includes configuration information for configuring the terminal to determine to leave the RRC connected mode to perform the GNSS measurement, determining to leave the RRC connected mode based on the configuration information; and
transmitting, to the first base station, a second message indicating to leave the RRC connected mode including a release cause.

3. The method of claim 1, the method further comprising:
in case that the first message is an RRC release message or an RRC connection reject message for configuring the terminal to leave the RRC connected mode, leaving the RRC connected mode as a response to the first message,
wherein the first message further includes second information for configuring the terminal to re-entering the RRC connected mode after performing the GNSS measurement.

4. The method of claim 1, re-entering the RRC connected mode comprising:
establishing an RRC connection with the second base station; and
transmitting, to the second base station, a third message including a GNSS validity duration.

5. A method performed by a base station in a wireless communication network, the method comprising:
generating a first message including first information indicating to perform a global navigation satellite system (GNSS) measurement in a radio resource control (RRC) inactive mode or an RRC idle mode; and
transmitting, to a terminal in a RRC connected mode, a first message including the first information indicating to perform GNSS measurement in the RRC inactive mode or the RRC RRC idle mode;
wherein the GNSS measurement is performed in the RRC inactive mode or the RRC idle mode based on the first information.

6. The method of claim 5, method further comprising:
in case that the first message further includes configuration information for configuring the terminal to determine to leave the RRC connected mode to perform the GNSS measurement, receiving, from the terminal,
a second message indicating to leave the RRC connected mode including a release cause,
wherein to leave the RRC connected mode is determined by the terminal based on the configuration information.

7. The method of claim 5,
wherein in case that the first message is an RRC release message or an RRC connection reject message for configuring the terminal to leave the RRC connected mode, whether to leave the RRC connected mode is based on the first message, and
wherein the first message further includes second information for configuring the terminal to re-entering the RRC connected mode after performing the GNSS measurement.

8. The method of claim 5, the method further comprising:
in case that a suitable cell belongs to the base station, re-establishing an RRC connection with the terminal; and
receiving, from the terminal, a third message including a GNSS validity duration.

9. A terminal in a wireless communication network, the terminal comprising:
a transceiver; and
a controller configured to:
receive, from a first base station, a first message including first information indicating to perform a global navigation satellite system (GNSS) measurement in a radio resource control (RRC) inactive mode or an RRC idle mode, in an RRC connected mode,
based on the first information, perform the GNSS measurement in the RRC inactive mode or the RRC idle mode, and
re-entering an RRC connected mode with a second base station,
wherein a suitable cell belong to the second base station.

10. The terminal of claim 9, wherein the controller is further configured to:
in case that the first message further includes configuration information for configuring the terminal to determine to leave the RRC connected mode to perform the GNSS measurement, determine to leave the RRC connected mode based on the configuration information, and
transmit, to the first base station, a second message indicating to leave the RRC connected mode including a release cause.

11. The terminal of claim 9, wherein the controller is further configured to:
in case that the first message is an RRC release message or an RRC connection reject message for configuring the terminal to leave the RRC connected mode, leave the RRC connected mode as a response to the first message,
wherein the first message further includes second information for configuring the terminal to re-entering the RRC connected mode after performing the GNSS measurement.

12. The terminal of claim 9, wherein the controller is further configured to:
establish an RRC connection with the second base station, and
transmit, to the second base station, a third message including a GNSS validity duration.

13. A base station in a wireless communication network, the base station comprising:
a transceiver; and
a controller configured to:
generate a first message including first information indicating to perform a global navigation satellite system (GNSS) measurement in a radio resource control (RRC) inactive mode or an RRC idle mode, and
transmit, to a terminal in a RRC connected mode, a first message including the first information indicating to perform GNSS measurement in the RRC inactive mode or the RRC RRC idle mode,
wherein the GNSS measurement is performed in the RRC inactive mode or the RRC idle mode based on the first information.

14. The base station of claim 13, wherein the controller is further configured to:
in case that the first message further includes configuration information for configuring the terminal to determine to leave the RRC connected mode to perform the GNSS measurement, receiving, from the terminal,
a second message indicating to leave the RRC connected mode including a release cause, wherein to leave the RRC connected mode is determined by the terminal based on the configuration information, and
wherein in case that the first message is an RRC release message or an RRC connection reject message for configuring the terminal to leave the RRC connected mode, whether to leave the RRC connected mode is based on the first message, wherein the first message further includes second information for configuring the terminal to re-entering the RRC connected mode after performing the GNSS measurement.

15. The base station of claim 13, wherein the controller is further configured to:
in case that a suitable cell belongs to the base station, re-establish an RRC connection with the terminal, and
receive, from the terminal, a third message including a GNSS validity duration.
